(19) United States
(12) Patent Application Publication
(10) Pub. No.: US 2022/0324708 A1
(43) Pub. Date: Oct. 13, 2022

(54) PROCESSES FOR PRODUCING SYNGAS STARTING FROM PRETREATED RECOVERY PLASTIC POLYMERS

(71) Applicants: POLITECNICO DI MILANO, Milano (Ml) (IT); CONSORZIO INTERUNIVERSITARIO NAZIONALE PER LA SCIENZA E TECNOLOGIA DEI MATERIALI (INSTM), Firenze (FI) (IT)

(72) Inventors: Flavio MANENTI, Milano (MI) (IT); Maurizio MASI, Milano (MI) (IT); Sergio MIELE, Firenze (FI) (IT); Enrica BARGIACCHI, Firenze (FI) (IT)

(21) Appl. No.: 17/630,866

(22) PCT Filed: Jul. 28, 2020
(86) PCT No.: PCT/IB2020/057097

§ 371 Date: Jan. 27, 2022

(30) Foreign Application Priority Data
Jul. 29, 2019 (IT) 102019000013239

(51) Int. Cl. C01B 3/38; B01J 8/06; C10K 3/02; C10J 3/84

(52) U.S. Cl. CPC C01B 3/382; C01B 3/384; B01J 8/065; B01J 8/067; C10K 3/023; C10J 3/84; C01B 2203/1241; C01B 2203/0233; C01B 2203/0238; C01B 2203/0833; C01B 2203/0811; C10J 2300/1861; C10J 2300/0946

(57) ABSTRACT

A process for producing syngas from pre-treated recovery plastic polymers comprising:

a) gasifying said recovery pre-treated polymers according to the following reaction scheme R1:

[—CH₂—]+H₂O═CO+2H₂; R1:

b) hydrogenating said pre-treated polymers to higher hydrocarbons and methane by using hydrogen produced in R1, according to the following reaction scheme R3:

[—CH₂—]ₙ+H₂═CₙH₍₂ₙ₊₂₎ R3:

wherein n is an integer of from 1 to 3, said reaction being optionally combined with oligomers and olefin formation reactions;
c) steam reforming of methane according to the following reaction scheme R4:

CH₄+H₂O═CO+3H₂; R4:

and optionally
d) reforming reaction of methane according to the following reaction scheme R5:

CH₄+CO₂=2CO+2H₂; R5:

said process being carried out in a plant (10), (20), (30), (40), (50) comprising a gasification section (11), (21), (31), (41), (51) and a reforming section (12), (22), (32), (42), (52) comprising a tube bundle (13), (23), (33), (43), (53) provided with a catalyst wherein,
i) said gasification (11), (21), (31) and reforming sections (12),(22), (32) are part of a sole reactive unit (10), (20), (30), or said gasification (41), (51) and reforming section (42), (52) are two physically distinct reactive units (40), (50),
ii) the gasification section (11), (21) or the reactive unit (41) provides respectively the energetical support to the reforming section (12), (22) or to the reforming reactive unit (42), thanks to the exothermic combustion reaction scheme R2:

[—CH₂-]+1.5O₂═CO₂+H₂O; R2:

or in alternative: the reforming section (32) or the reforming reactive unit (52) provides energetic support to the corresponding gasification section (31) or gasification reactive unit (51), thanks to the exothermic combustion reaction scheme R6:

CH₄+2O₂═CO₂+2H₂O. R6:

### FIELD OF THE INVENTION

The present invention relates to a process for treating recovery plastic materials and related syngas production.

### STATE OF THE ART

The treatment of recovery plastic material represents one of the major problems for environmental pollution, which worsens from year to year.

In the related art exist processes for disposal of plastic by thermal treatments of pyrolysis, combustion and gasification. One of these is disclosed, e.g. in CN 105733687. In particular, in addition to the syngas, which represents the main product, the known processes allow to obtain volatile combustion gases, e.g. some light hydrocarbons, aromatic hydrocarbons and different families of aldehydes, ketones and alcohols, together with CO₂.

Other examples of known processes for the treatment of biomass are described in WO2016142903 and DE 102009057109. The first of these describes a gasification-only process for the production of methane starting from natural coal biomass.

In detail, document WO2016142903 describes a methane production process starting from coal produced from biomass with the addition of hard coal.

DE102009057109 relates to a process for the production of syngas and coal characterized in that the coal formed is partially removed during gasification, and the pyrolysis gas is subjected to a catalytic scavenging to give syngas.

Therefore, it is felt the need to have a process for the disposal of recovery plastic which allows not only to minimize unwanted products but is as efficient as possible, even from an energy standpoint.

### SUMMARY OF THE INVENTION

In order to overcome the aforementioned problems, a process which allows the treatment of plastic polymers with the production substantially of sole syngas intended for the synthesis of chemical products with high added value and a minimum part of CO₂, originating from the energy self-sustainability need of the whole conversion process, has been conceived.

It is therefore an object of the present invention a process for producing syngas from pre-treated recovery plastic polymers comprising:

a) gasifying of the recovery pre-treated polymers according to the following reaction scheme R1:

[—CH₂—]+H₂O═CO+2H₂ R1:

b) hydrogenating said pre-treated polymers to higher hydrocarbons and methane by using hydrogen produced in R1, according to the following reaction scheme R3:

[—CH₂-]n+H2=CnH(2n+2); R3:

wherein n is an integer comprised between 1 and 3, said reaction R3 being optionally combined with oligomers and olefin formation reactions;

c) steam reforming of methane according to the following reaction scheme R4

CH4+H2O═CO+3H2 R4:

and optionally

d) reforming reaction of methane according to the following reaction scheme R5:

CH4+CO2=2CO+2H2 R5:

said process being carried out in a plant comprising a gasification section and a reforming section comprising a tube bundle equipped with a catalyst in which:

i) said gasification and reforming sections are part of a sole reactive unit or said gasification section and said reforming section are two physically distinct reactive units.

ii) the gasification section or reactive unit provides energy support to the corresponding reforming section or reactive unit, thanks to the exothermic combustion reaction R2

[—CH₂-]+1.5O₂═CO2+H₂O R2:

or in alternative

the reforming section or reactive unit provides energy support to the corresponding gasification section or unit

thanks to the exothermic combustion reaction scheme R6:

CH₄+2O₂═CO₂+2H₂O, R6:

### DESCRIPTION OF DRAWINGS

FIG. 1: a schematic representation of a reactive unit in which the reforming section and the gasification section are contained in a sole reactive unit of the plant according to a first embodiment of the present invention;

FIG. 2: a schematic representation of a reactive unit in which the reforming section and the gasification section are contained in a sole reactive unit of the plant according to a second embodiment of the present invention;

FIG. 3: a schematic representation of a reactive unit in which the reforming section and the gasification section are contained in a sole reactive unit of the plant according to a third embodiment of the present invention;

FIG. 4: a schematic representation of a reforming reactive unit and a gasification reactive unit physically distinct from each other of the plant according to a fourth embodiment of the present invention;

FIG. 5: a schematic representation of a reforming reactive unit and a gasification reactive unit physically distinct from each other of the plant according to a fifth embodiment of the present invention;

FIG. 6: a block diagram representation of a syngas production plant integrated with an air-into-nitrogen and oxygen separation unit

FIG. 7: a block diagram representation of a plant for the production of syngas according to an embodiment of the present invention, integrated with units intended for the production of high added value products;

FIG. 8: a block diagram representation of a plant for the production of syngas according to an embodiment of the present invention integrated with a unit intended for the production of fuels according to the Fisher-Tropsch synthesis;

FIG. 9: a block diagram representation of a plant for the production of syngas according to the embodiment of FIG. 1 integrated with an air-into-nitrogen and oxygen separation unit and a plastic material pre-treating unit.

### DETAILED DESCRIPTION

The process according to the present invention allows the chemical conversion of organic solids and in particular of a plurality of plastics, known to the skilled person in the field as “plasmix”, defined as a set of heterogeneous plastics included in post-consumer packaging and not recovered as individual polymers. This process is carried out within a plant.

For the purposes of the present invention, by “plant” is meant a set of one or more reactive units possibly associated with one or more units for purification and separation of the products exiting from the reactive units.

For the purposes of the present invention, by the definition of “reactive unit” is meant a unit in which the partial or total conversion of the reacting gases entering said reactive unit takes place.

For the purposes of the present invention, the definition of “comprising” does not exclude the presence of further components in addition to those indicated next to the above definition.

For the purposes of the present invention, the definition of “consisting of” and “consisting in” excludes the presence of further components other than those listed next to such definitions.

For the purposes of the present invention, the definition of “chemically integrated” means that the streams leaving one section are partially/completely used as reactants in the other section.

For the purposes of the present invention, the definition of “thermally integrated” means that the thermal energy produced in one of the sections is used for the operation of the other section.

In particular, the gasification and reforming sections of the plant are in fluid communication so that the streams leaving one section are at least partially the streams entering the other section. Furthermore, the streams exchanged and produced in the corresponding sections allow the energy self-sustaining of the two sections to conduct the reactions.

Preferably, the recovery plastic polymers, before being supplied to one of the sections of the plant according to the present invention, are pre-treated before entering the plant. In particular, the process comprises a pre-treatment step of the plastic polymers before the subsequent steps. In detail, the plastic polymers are treated with liquid nitrogen and subsequent comminution in a pre-treatment unit referred to in the figures as PRE-TREAT. The use of liquid nitrogen allows the plastic surfaces and bulks to be stiffened, making them easier to break up during comminution.

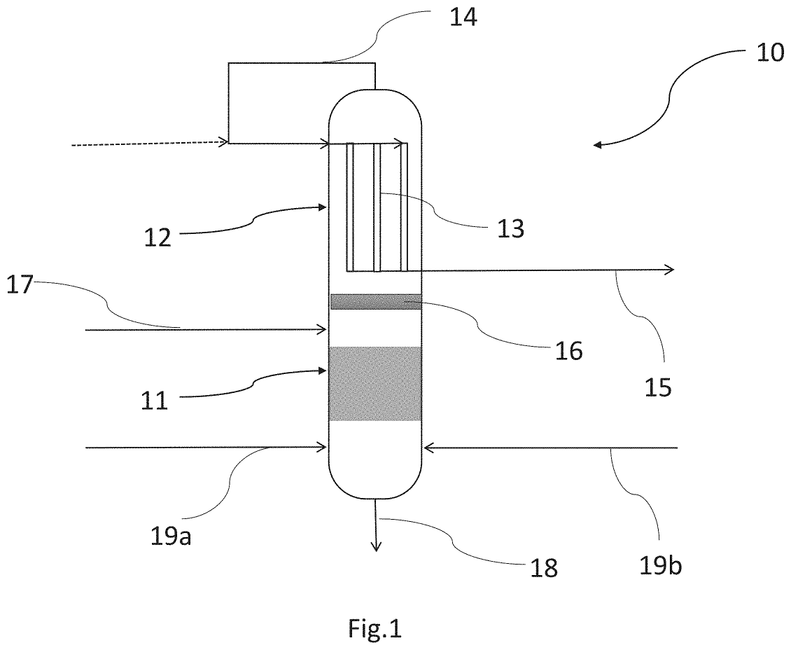

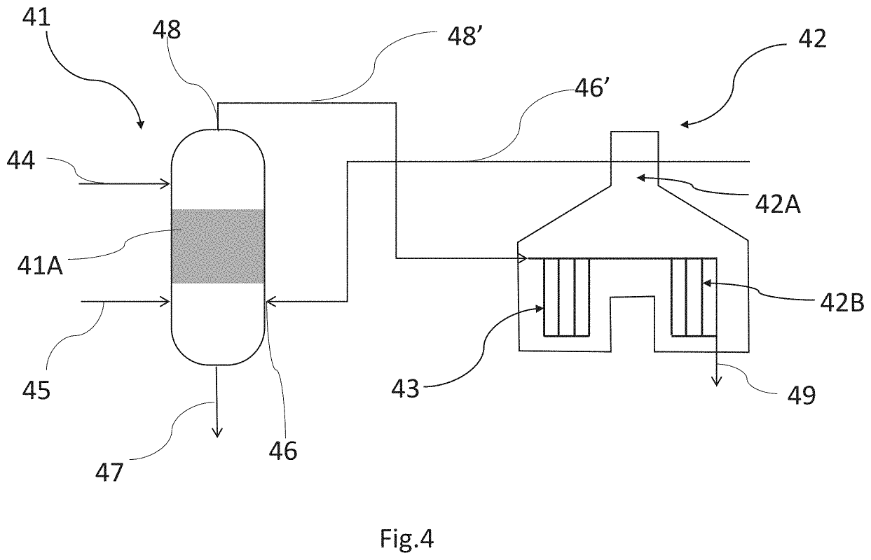

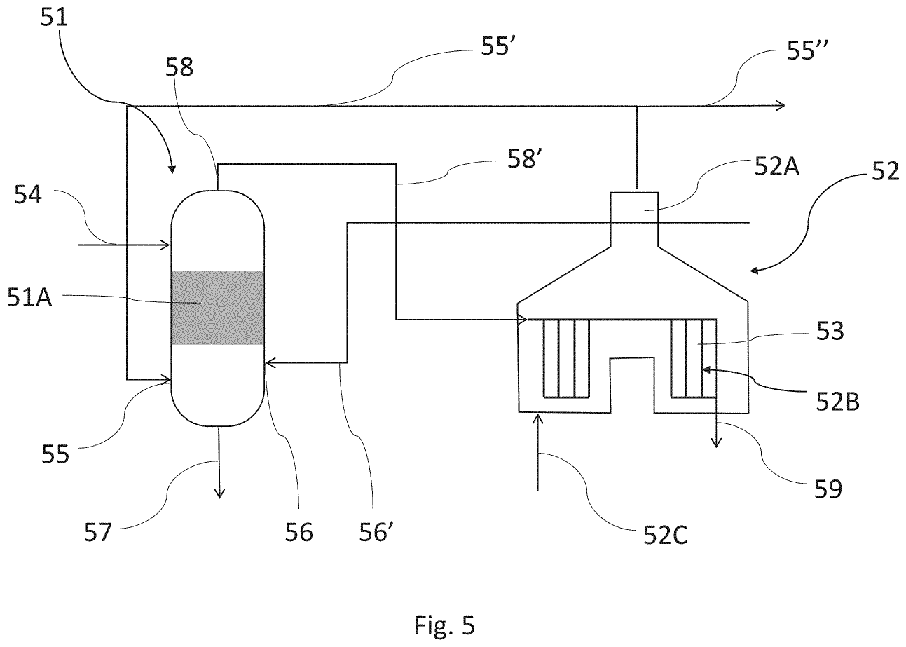

According to the present invention, the gasification and reforming sections can be combined according to two integration mode:
“Composed”, with reference to FIGS. 1-3, in which the gasification section 11, 21, 31 and the reforming section 12, 22, 32 are part of a sole reactive unit 10, 20, 30:
“Decomposed”, with reference to FIGS. 4 and 5, in which the gasification section 41, 51 and the reforming section 42, 52 are two physically distinct reactive units 40, 50.

In accordance with the embodiments of the present invention, the “Composed” integration mode has three variants while the “Decomposed” integration mode has two variants.

First variant of the “Composed” mode (FIG. 1)

According to the first variant, in the reactive unit 10 the reforming section 12 is positioned above the gasification section 11. Preferably, the reactive unit 10 comprises:
on the top, a recycling system 14 that recycles the effluents coming from the shell side of the tube bundle 13 conveying them into the tube bundle 13 on the tube side;
an outlet 15 from which the reacted gases exit in the tube side of the tube bundle 13 of the reforming section 12;
a porous plug 16 arranged between the gasification section 11 and the reforming section 12 to allow only the passage of gas from the gasification section to the reforming section;
an inlet 17 for the pre-treated polymeric material arranged between the porous plug 16 and the gasification section 11;
an exhaust tube 18 for the solid residue produced in the gasification section 11 at the end of the reactive unit 10;
at least one inlet 19a, 19b of the gaseous reactants below the gasification section 1 above the exhaust tube 18.

According to the embodiment of FIG. 1, the process provides for a step of introducing the mixture of pre-treated plastic polymers into the reactive unit 10 via the inlet 17 arranged between the reforming section 12 and the porous plug 16, reaching the gasification section 12 by free fall.

Preferably, the reactive unit 10 comprises two inlets for the reactants 19a, 19b from which oxygen and water steam are supplied to the gasification section 11. In this way, the mixture of plastic polymers pre-treated during the fall, with an unstructured motion, comes into contact in countercurrent with the mixture of steam and oxygen.

The process therefore involves the step of gasifying in the gasification section 11. In detail, the mixture of plastic polymers is gasified according to the endothermic reaction R1:

[—CH₂—]+H₂O═CO+2H₂ R1:

Subsequently, the process involves a combustion step. In particular, the mixture of plastic polymers is partially burned thanks to the oxygen introduced into the gasification section 11 according to the exothermic reaction R2:

[—CH₂-]+1.5O₂═CO₂+H₂O R2:

This reaction R2 is carried out using an amount of oxygen lower than the stoichiometric one, preferably ⅓ of the stoichiometric one.

It should be noted that the reaction R1 is realized thanks to the energy developed during the reaction R2. In other words, the reaction R2 provides in situ the energy needed to overcome the endothermicity of the gasification reaction R1.

In the gasification section 11, the step of hydrogenating the pre-treated polymers with higher hydrocarbons and methane also takes place, with the hydrogen produced in the reaction R1. In fact, due to the presence of oxygen and hydrogen, methane and/or higher hydrocarbons are produced according to the reaction R3:

[—CH₂—]ₙ+H₂═CₙH₍₂ₙ₊₂₎; R3:

wherein n is an integer comprised between 1 and 3, said reaction R3 being optionally combined with oligomers formation reactions. In particular, the mixture of pre-treated plastic polymers is partially transformed into methane according to the reaction R3 in the presence of hydrogen formed during gasification according to the reaction R1. From the reactions which take place in the gasification section 11 there is the production of a gas mixture containing H₂, CH₄ and light hydrocarbons. Furthermore, solid residues are obtained as a waste product which are separated from the gaseous mixture by the separator 16, preferably a porous plug made of ceramic material, a mesh also made of ceramic material, or a cyclone made of ceramic material, and remain trapped there or fall down by gravity at the end of the reactive unit 10, where through the exhaust tube 18 they are expelled from the unit.

It should be noted that the gases produced during gasification depend on the composition of the mixture of pre-treated plastic polymers. In the following, by way of example, are showed a first table with the composition of the plasmix and a second table with the gases produced.

TABLE 1

| Polimero | % m/ht |
|---|---|
| PE | 40-50 |
| PP | 20-30 |
| PS | 10-20 |
| PET | 5-10 |
| PVC | 2-5 |
| ALTRO | 5-15 |

TABLE 2

| | λ = 0.2 | | λ = 0.25 | | λ = 0.3 | |
|---|---|---|---|---|---|---|
| | Exp. | Pred. | Exp. | Pred. | Exp. | Pred. |
| N₂ | 0.828 | 0.839 | 0.828 | 0.827 | 0.84 | 0.816 |
| H₂ | 0.084 | 0.033 | 0.07 | 0.034 | 0.066 | 0.035 |
| CO₂ | 0.013 | 0.008 | 0.012 | 0.012 | 0.016 | 0.016 |
| CO | 0.044 | 0.062 | 0.054 | 0.073 | 0.054 | 0.083 |
| CH₄ | 0.026 | 0.025 | 0.027 | 0.024 | 0.02 | 0.024 |
| C₂—C₄ | 0.005 | 0.029 | 0.009 | 0.026 | 0.005 | 0.024 |
| C₀ + (benzene) | — | 0.005 | — | 0.004 | — | 0.003 |

In table 2 the Greek letter lambda indicates the amount of oxygen supplied to gasification compared to the amount of stoichiometric oxygen for complete oxidation.

According to a preferred embodiment, the mixture of polymers enters from inlet 17 and undergoes the following treatments:
drying in case that excessive humidity is present after the pre-treatment of the recovery polymeric material;
partial pyrolysis;
gasification by means of the steam introduced into the gasification section 11 according to the reaction R1;
partial combustion according to the reaction R2;
partial cooling thanks to the relatively cold streams of steam and oxygen supplied to the reagent inlets 19a, 19b, having temperatures lower than the temperatures reached during combustion;
elimination of solid residues through the exhaust tube 18.

The gas mixture produced in the gasification section 11 purified from solid residues enters the reforming section 12 from the shell side, heating the tube bundle 13 and cooling down to the reforming temperature. Subsequently, the gas mixture which has passed through the tube bundle 13 from the shell side exits from the top of the reforming section 12 and then from the reactive unit 10. This outlet stream is conveyed to the tube side in the reforming section by means of the recycle 14, preferably a refractory duct. Alternatively, the gas mixture which has passed through the tube bundle 13 from the shell side remains in the head of the reforming section 12 and, turning downwards, is conveyed inside the tubes of said section without leaving the reactive unit 10.

In the tube bundle 13 on the tube side in the reforming section 12 the steam reforming step is carried out. In fact, the steam reforming reaction R4 takes place on the tube side in the reforming section:

CH₄+H₂O═CO+3H₂ R4:

Optionally, the gas mixture exiting the head of the reactive unit 10 before entering the tube bundle 13 from the tube side can be added to a stream of fresh steam to shift the reforming reaction R4 to the right.

The reaction R4, also endothermic, is energetically supported by the mixture of hot gases present in the shell side and coming from the gasification section 11.

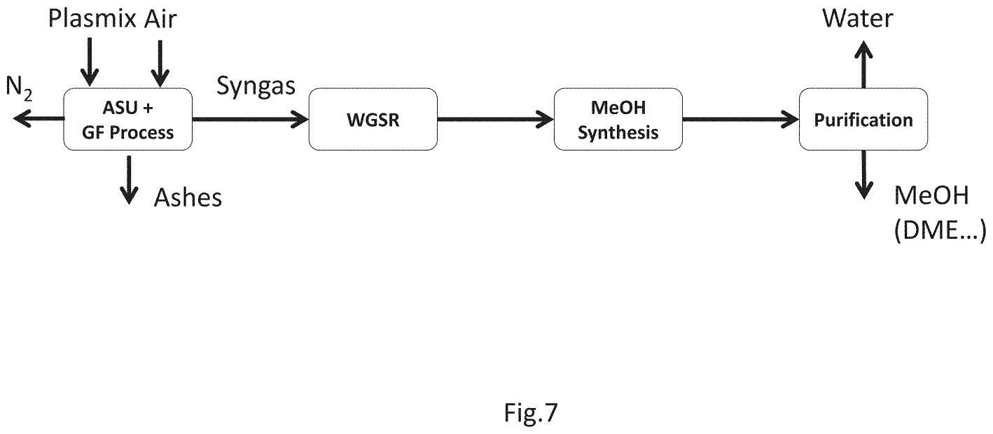

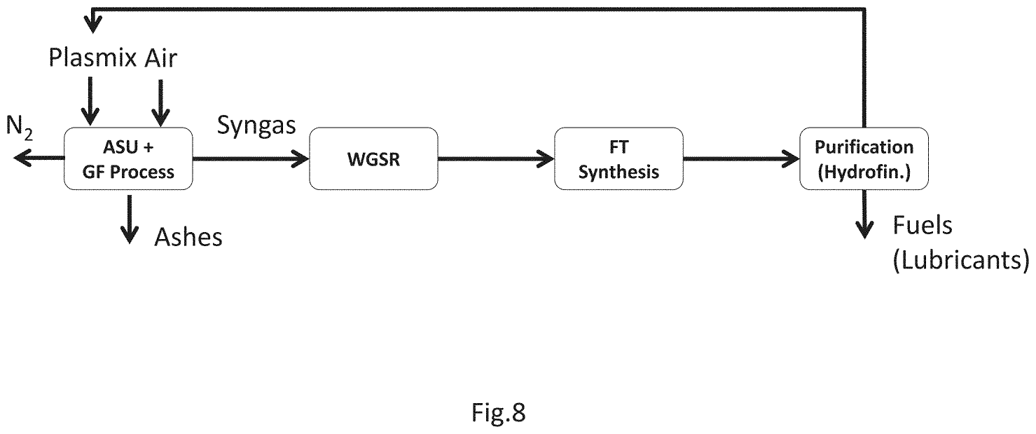

Subsequently, the syngas produced in the reforming section 12 on the tube side exits the outlet 15 and is directed to a further unit or section of the plant downstream of the reactive unit 10 such as e.g. in the synthesis plants of FIGS. 7 and 8, which will be described in detail later.

Advantageously, the combination of the gasification and reforming sections allows the energy produced during gasification to be recovery in order to favor the reforming reaction.

Advantageously, the combination allows the complete conversion of the plasmix, also of its hydrocarbon part, into syngas.

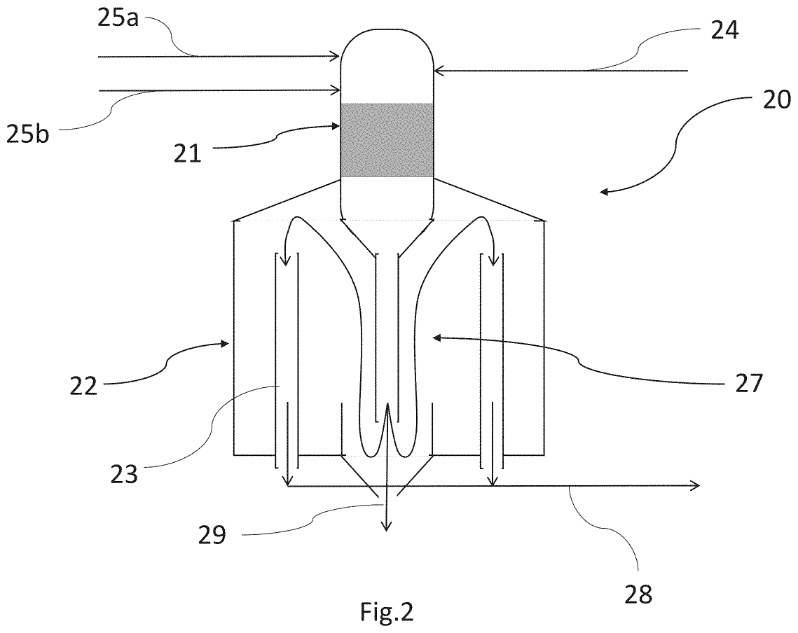

Second variant of the “Composed” mode (FIG. 2)

The second variant provides that in the reactive unit 20 the reforming section 22 is positioned under the gasification section 21 according to a version called “downdraft”. In particular, the second variant has the gasification section 21 at the top and the reforming section 22 at the tail.

In detail, the reactive unit 20 includes:
an inlet for the pre-treated plastic polymer 24 and at least one inlet 25a, 25b for the gaseous reactants positioned above the gasification section 21;
a cyclonic section 27, which allows the removal of solid residues from the gaseous mixture before it is conveyed into the tube bundle 23 on the tube side;
an outlet 28, in which the reacted gases are conveyed into the tube bundle.

According to the present invention, the pre-treated mixture of plastic polymers is introduced into the reactive unit 20 through inlet 24 and descends by gravity in equilibrium with a mixture of steam and oxygen entering from inlets 25a, 25b, also arranged above the gasification section. The mixture of plastic polymers together with oxygen and steam reaches the gasification section 21 where the mixture of plastic polymers pre-treated according to the process of the invention takes place the step of:
gasifying according to endothermic reaction R1 thanks to the energy developed by its partial combustion with oxygen according to the exothermic reaction R2:

[—CH₂—]+H₂O═CO+2H₂ R1:

[—CH₂-]+1.5O₂═CO₂+H₂O R2:

using, also in this case, in the reaction R2 a quantity of oxygen lower than the stoichiometric one, preferably ⅓ of the stoichiometric one;
hydrogenation where it partially transforms into methane and/or higher hydrocarbons according to the reaction R3 in the presence of hydrogen formed during gasification according to the reaction R1 giving rise to a mixture of gas and solid residues:

[—CH₂—]ₙ+H₂═CₙH₍₂ₙ₊₂₎; R3:

wherein n is an integer between 1 and 3, this reaction is optionally combined with oligomer formation reactions. It should be noted that the mixture of pre-treated plastic polymers, once in contact with the stream of oxygen and steam, undergoes the same treatments received in the first variant described above.

The gases and solid residues are discharged through an elongated duct which places the gasification section 21 in fluid communication with the cyclonic section 27. In this way, the solid residues are separated from the gaseous mixture by means of the cyclonic section 27 and expelled from the unit by means of the exhaust tube 29. Subsequently, the hot gas mixture, coming from the gasification, is conveyed to the tube side into the tube bundle 23 of the reforming section 22, going up the chamber of the reforming section 23. Once the gas mixture has entered the tube bundle 23 on the tube side, it is transformed into syngas according to the steam reforming reaction R4:

CH₄+H₂O═CO+3H₂ R4:

After the step of steam reforming is carried out, the syngas produced in the reforming section 22 on the tube side leaves through the outlet 28 from which it is subsequently conveyed to a further unit or section of the plant downstream of the reactive unit 20.

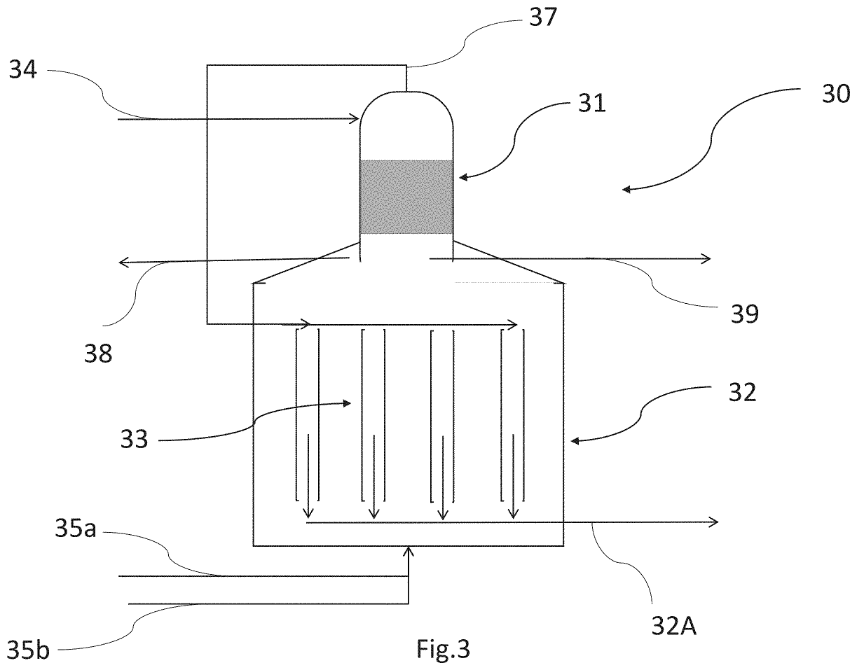

Third variant of the “Composed” mode (FIG. 3)

The plant according to the third variant of the present integration method has within the reactive unit 30 the reforming section 32 positioned under the gasification section 31.

In detail, the reactive unit 30 includes:
an inlet 34 for the pre-treated plastic polymer arranged above the gasification section 31;
at least one inlet 35a, 35b for the reagent gases at the bottom of the reforming section 32,
a recycling 37 at the top of the reactive unit for the gases produced in the gasification section 31 and exiting at the top of the unit 30. Such recycling 37 allows the outgoing gases to be conveyed into the tube bundle 33 on the tube side,
an exhaust tube 38 for the gases on the shell side;
an ash removal system 39 between the gasification section 31 and the reforming section 32,
an outlet 32A of syngas produced in the tube bundle of the reactive unit 30.

In detail, a mixture of oxygen and methane enters the reforming section through the inlet 35a, 35b, which supplies the thermal power to the reactive unit 30 through the reaction R6:

CH₄+2O₂═CO₂+2H₂O R6:

This exothermic R6 reaction allows to generate effluents substantially containing only CO₂ and steam.

The gases thus produced by reaction R6, with the exception of a part extracted from the exhaust tube 38, rise towards the gasification section volatilizing in countercurrent the mixture of pre-treated plastic polymers supplied to the gasification section according to the reaction R1 of the gasification step:

[—CH₂—]+H₂O═CO+2H₂ R1:

Subsequently, the mixture of gas exiting at the top of the reactive unit 30 and originating from the gasification section is mostly sent by recycling 37 to the reforming section 32. This mixture of gas leaving at the top is then conveyed into the tube bundle 33 on the tube side where the R4 and R5 reactions take place according to the steps of the steam reforming and R5 reaction process:

CH₄+H₂O═CO+3H₂ R4:

CH₄+CO₂=2CO+2H₂ R5:

to produce syngas. The gas so produced by the reactions R4 and R5 is subsequently conveyed and sent through the outlet 40 to a further unit or section of the plant downstream of the reactive unit 30.

It should be noted that the solid residues are separated by conventional separation by means of an exhaust tube arranged between the two sections 31 and 32.

First Variant of the “Decomposed” Mode (FIG. 4)

The first variant of the plant according to the “decomposed” integration mode therefore comprises a gasification reactive unit 41 and a reforming reactive unit 42 which has a convective zone 42A above a radiant zone 42B in which a tube bundle 43 is arranged. In particular, in addition to the gasification unit 41 and the reforming unit 42, this plant includes:
a section 41A arranged at the center of the gasification unit, where the gasification reaction takes place
the inlet 44 of the pre-treated polymeric material arranged above the section 41A of the gasification unit;
the oxygen inlet 45 arranged under section 41A,
the pre-heated steam inlet 46 into the convection zone of the reforming reactive unit 42 and conveyed to said inlet through the line 46′;
the solid residue outlet 47 arranged at the bottom of the reactive unit 41;
the outlet 48 of the gases produced in the gasification unit 41, which are then conveyed through the line 48 ‘and sent to the reforming reactive unit 42 in the tube bundle 43 on the tube side;
an outlet 49 in the reforming unit 42 for the gases reacted in the tube bundle 43.

In detail, the mixture of pre-treated plastic polymers is supplied above the section 41A of the gasification unit 41 through inlet 44. As this mixture of pre-treated plastic polymers descends, by gravity, it comes into contact in countercurrent with a mixture of steam and oxygen entering the gasification unit 41 below the zone 41A and above the exhaust tube of the solid residues 47.

In particular, the mixture of pre-treated plastic polymers gasifies according to the endothermic reaction R1, thanks to the energy developed by its partial combustion with oxygen according to the exothermic reaction R2 as for the first and second variant of the “composed” integration mode:

[—CH₂—]+H₂O═CO+2H₂ R1:

[—CH₂-]+1.5O₂═CO₂+H₂O R2:

Also, in this case a lower quantity of oxygen is used with respect to the stoichiometric one, preferably ⅓ of the stoichiometric one.

Furthermore, the mixture of pre-treated plastic polymers is partially transformed into methane and/or higher hydrocarbons during the hydrogenation step according to the following reaction R3

[—CH₂—]ₙ+H₂═CₙH₍₂ₙ₊₂₎; R3:

in the presence of hydrogen formed during gasification according to the reaction R1: where n is an integer comprised between 1 and 3. This reaction R3 is optionally associated with oligomer formation reactions. These reactions produce a mixture of gases and solid residues, the latter fall by gravity in the tail of the reactive unit 41 where they are removed through the outlet 47.

It should be noted that also in this case the mixture of pre-treated plastic polymers preferably undergoes the same treatments for the first variant of the “composed” mode.

Subsequently, the gas mixture coming from the gasification rises towards the head of the reactive unit 41 from which it exits via the outlet 48 and is conveyed via the line 48′ to the tube bundle 43 on the tube side of the reforming reactive unit 42.

In this way, the reaction R4 is carried out in the tube bundle 43 for the production of syngas according to the step of the steam reforming process R4:

CH₄+H₂O═CO+3H₂ R4:

The gases produced in the tube bundle leave the reactive unit 42 through the outlet 49 and are sent to a further unit or section of the plant downstream of the reactive unit 42.

Second Variant of the “Decomposed” Mode (FIG. 5)

The second variant of the plant according to the “decomposed” integration mode therefore comprises a gasification unit 51 and a reforming unit 52 having a convective zone 52A above a radiant zone 52B in which a tube bundle 53 is arranged. In this variant, as in the third variant of the “composed” mode, the reacting gases, such as oxygen and methane, are supplied on the reforming reactive unit side.

In particular, the plant according to the present invention comprises, in addition to the gasification reactive unit 51 and the reforming reactive unit 52, also:
a gasification section 51A arranged at the center of the gasification unit, where the gasification reaction takes place;
the inlet 54 of the pre-treated polymeric material arranged above the section 51A of the gasification unit;
the inlet 55 of the gasification unit of the burnt gases produced in the reforming unit 52 on the shell side and conveyed to the inlet 55 thanks to the line 55′ to less than a portion expelled through a exhaust line 55″;
an inlet 56 of the gasification reactive unit (51) for the pre-heated steam in the convective area of said reforming unit 52;
the solid residues 57 of the gasification unit exit from the bottom of the reactive unit 51;
the reacted gases outlet 58 from the gasification unit 51 which are then conveyed through the line 58′ and through this enter the reforming reactive unit 52 in the tube bundle 53
an outlet 59 of the reforming unit 52 for the gases produced in the tube bundle 53.

In detail, the mixture of pre-treated plastic polymers is supplied to the gasification unit 51 through the inlet 54 and descends by gravity towards the bottom of the gasification reactive unit 51. This mixture comes into contact in counter-current with a mixture of pre-heated steam in the convection zone of the reforming reactive unit 52 and conveyed to said inlet 56 through line 56′. Furthermore, the mixture comes into contact in countercurrent with a mixture of steam and CO₂ coming from the combustion of methane with oxygen according to the reaction R6 which takes place on the shell side in the reforming unit 52:

CH₄+2O₂═CO₂+2H₂O R6:

It should be noted that the oxygen and methane streams are fed into the reforming unit 52 by means of an inlet 52C.

In this way, the gasification step of the mixture of plastic polymers pre-treated according to the reaction R1 takes place and, subsequently, the solid residues are removed through the exhaust tube 57:

[—CH₂—]+H₂O═CO+2H₂ R1:

The gases thus reacted go up to the gasification unit up to the head of the reactive unit 51 from which they come out through the outlet 58 and are conveyed via the line 58′ to the reforming reactive unit 52.

Subsequently, the gases exiting the head of the gasification unit enter from the tube side into the tube bundle 53, arranged in the radiant zone 52B of the reforming unit 52, where the reactions R4 and R5 are carried out according to the reactions:

CH₄+H₂O═CO+3H₂ R4:

CH₄+CO₂=2CO+2H₂ R5:

The gases thus formed in the tube bundle leave the reforming unit 52 and through the outlet 59 are sent to a further unit or section of the plant downstream of the reactive unit 52.

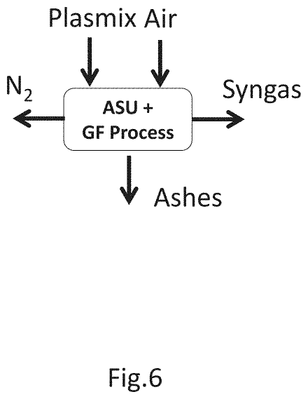

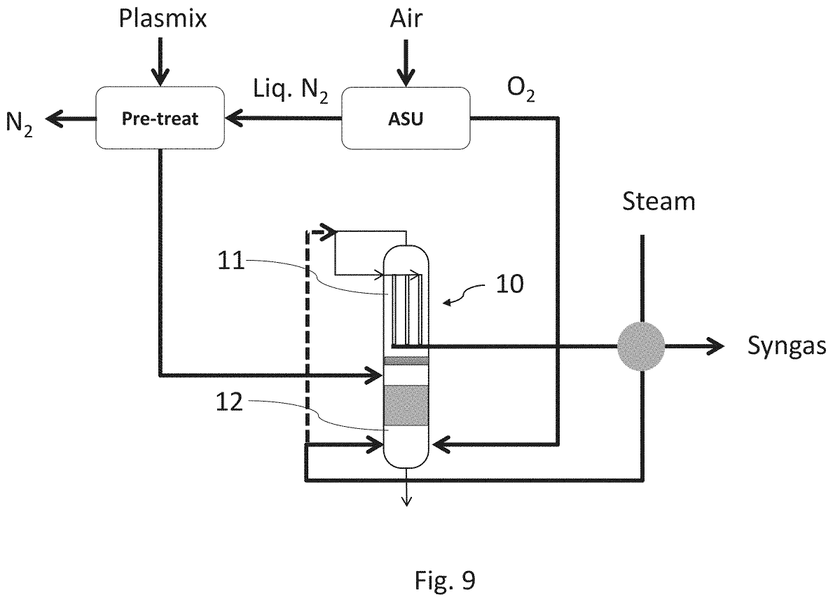

Preferably, the plant in which the process according to the present invention is conducted is integrated with an air separation unit ASU, as illustrated in FIGS. 6-9, which allows the production of oxygen to be introduced into the gasification sections 11, 21, 31, 41, 51 or reforming 12, 22, 32, 42, 52 and nitrogen used in the PRE-TREAT pre-treatment unit to pre-treat the plastic polymers.

Advantageously, the use of the air separation unit ASU allows to separate the air into nitrogen and oxygen; the first for the pre-treatment of the plasmix and the second to be used in the gasification or reforming sections of the plant according to the present invention.

According to a preferred embodiment of the present invention, the air separation unit ASU is combined with the two gasification and reforming sections as illustrated in FIG. 6. In this way, the combination of the two aforementioned sections indicated in the figure with GF and with the air separation unit ASU receives incoming plasmix and air and supplies outcoming syngas, releasing nitrogen and solid residues as the only by-products and optionally exhaust gases.

The combination of the sections with the air separation unit ASU can be integrated with the units of a typical plant for chemical syntheses that contemplate the use of syngas as a reagent, as, e.g., in FIG. 7, where the above combination is used for the production of methanol or its derivatives (e.g. formaldehyde and/or dimethyl ether (DME)) or in the plants where Fisher-Tropsch synthesis takes place for the production of fuels and/or lubricants. In other words, the plant where the process of the invention is conducted can be integrated with plants that use syngas as a reagent for the production of high added value chemicals.

In particular, the combination of the sections with the air separation unit ASU is arranged upstream of the plant according to the present invention.

The gasification section in the plant object of the present invention is of the fluidized bed or dragged bed type.

Preferably, the reforming section 12, 22, 32 is of the catalytic bed type, preferably catalytic fixed bed. More preferably, the reforming section 12, 22, 32 is replaced with the catalytic bed, in particular with the fixed catalytic bed.

It should be noted in particular that according to the embodiments of the present invention the gasification section 11, 21 and the gasification reactive unit 41, illustrated respectively in FIGS. 1, 2 and 4, provide the energy support thanks to the exothermic reactions respectively to the section reforming unit 12, 22, and the reforming reactive unit 42. In this way, the latter do not require an energy supply from further units or sections other than the gasification ones.

Vice versa, according to the embodiments of the present invention, the reforming section 32 and the reforming reactive unit 52, illustrated in FIGS. 3 and 5, provide energy support thanks to the exothermic reactions respectively to the gasification section 31 and to the reactive unit of gasification 51. Also, in this case, the latter do not require an energy supply from other units or sections other than the reforming ones.

In other words, according to the present invention, the combination of gasification and reforming according to both the “composed” and “decomposed” integration modes allows the energy self-sustaining of one of said reforming sections, thus avoiding further energy supplies from other units and sections.

### Application Example Relating to the First Variant of the “Composed” Integration Mode

A flow sheet for fitting the experimental data was developed with the aid of a commercial simulator. The plasmix was represented by a current of only polyethylene, which qualitatively exhibits the same degradation behavior as polystyrene and polypropylene, except for small differences in ignition and depolymerization temperatures.

The pre-treated polyethylene is fed to the gasification section and encounters a mixture of steam and oxygen in counter current. The polyethylene gasifies and the syngas with methane and other volatile monomers goes to the reforming section where the conversion to syngas is completed. The combination of the two sections is powered as follows:
Polyethylene at 50° C.;
Steam at 400° C.;
Oxygen 250° C.

The gasification section reaches up to 1240° C. and the reforming section goes down to 750° C. on the tube side. To reach this temperature profile, the fraction of oxygen required remains within the limits required for gasification, i.e., sub-stoichiometric less than or equal to ⅓ of the stoichiometric one.

The following table shows the benefits in the production of syngas with the new unit, called gasiformer, compared to the use of a conventional gasifier.

TABLE 3

| Species | Gasification only (classical process) | Gasiformer |
|---|---|---|
| N2 | 0.828 | 0.713 |
| H2 | 0.07 | 0.184 |
| CO2 | 0.012 | 0.010 |
| CO | 0.054 | 0.093 |
| CH4 | 0.027 | 0 |
| C2-C4 | 0.009 | 0 |
| H2/CO ratio | 1.30 | 1.98 |

1-16. (canceled)

17. A process for producing syngas from pre-treated recovery plastic polymers comprising:
a) gasifying said recovery pre-treated polymers according to the following reaction scheme R1:
[—CH₂—]+H₂O═CO+2H₂ R1:
b) hydrogenating said pre-treated polymers to higher hydrocarbons and methane by using hydrogen produced in R1, according to the following reaction scheme R3:
[—CH₂—]ₙ+H₂═CₙH₍₂ₙ₊₂₎; R3:
wherein n is an integer comprised between 1 and 3, said reaction R3 being optionally combined with oligomers and olefin formation reactions;
c) steam reforming of methane according to the following reaction scheme R4:
CH₄+H₂O═CO+3H₂ R4:
and optionally
d) reforming reaction of methane according to the following reaction scheme R5:
CH₄+CO₂=2CO+2H₂; R5:
said process being carried out in a plant selected from the group consisting of:
(I) a unique reactive unit comprising a gasification section and a reforming section comprising a tube bundle provided with a catalyst; or
(II) two physically distinct reacting units: the gasification unit and the reforming unit comprising a tube bundle provided with a catalyst,
wherein:
i) the gasification section or the gasification reactive unit provides respectively energetical support to the reforming section or to the reforming reactive unit, thanks to the exothermic combustion reaction scheme R2:
[—CH₂-]+1.5O₂═CO₂+H₂O R2:
or in alternative
ii) the reforming section or the reforming unit provides energetic support to the corresponding gasification section or gasification reactive unit,
thanks to the exothermic combustion reaction scheme R6:
CH₄+2O₂═CO₂+2H₂O. R6:

18. The process of claim 17, being carried out in the plant of class (I) wherein the reforming section is arranged above the gasification section and said plant of class (I) comprises:
on the top, a recycling system that recycles the effluents coming from the shell side of the tube bundle conveying them into said tube bundle on the tube side;
an outlet for the exit of the reacted gases on the tube side of said tube bundle of said reforming section;
a gas-solid separator arranged between the gasification section and the reforming section, to allow only the passage of gas from the gasification section to the reforming section;
an inlet of the pre-treated polymeric material, said inlet being arranged between the separator and the gasification section;
an exhaust tube of the solid residue produced in the gasification section at the bottom of said reactive unit;
at least one inlet of the gaseous reactants below the gasification section above the exhaust tube.

19. The process of claim 18, wherein said mixture of pre-treated plastic polymers is introduced into said reactive unit through the inlet arranged between the reforming section and the separator, reaching the gasification section by gravity;
in said gasification section, said mixture of pre-treated plastic polymers, contacting in countercurrent a mixture of steam and oxygen entering said plant of type (I) below the gasification section and above the exhaust tube of the solid residues, through the at least one inlet
gasifies according to the endothermic reaction R1:
[—CH₂—]+H₂O═CO+2H₂ R1:
thanks to the energy developed by its partial combustion with oxygen according to the exothermic reaction R2:
[—CH₂-]+1.5O₂═CO₂+H₂O, R2:
is partially transformed into methane and/or higher hydrocarbons according to the reaction R3:
[—CH₂—]ₙ+H₂═CₙH₍₂ₙ₊₂₎; R3:
wherein n is an integer comprised between 1 and 3 in the presence of hydrogen formed during the gasification according to the reaction R1 giving rise to a mixture of gases and solid residues, the aforementioned reaction R3 being possibly combined with the formation of oligomers and olefins,
and wherein:
the solid residues are separated from the gaseous mixture by the separator and fall by gravity at the bottom of the reactive unit of class (I), where they are expelled through the exhaust tube, while the hot gas mixture produced in the gasification section purified from the solid residues enters the reforming section on the shell side heating the tube bundle and cooling down to the reforming temperature, leaves through the top of the reforming section the reactive unit of class (I), and, by means of the recycling system to which a fresh steam stream is possibly added, is conveyed on the tube side of the tube bundle in the reforming section, where the steam reforming reaction R4 takes place:
CH₄+H₂O═CO+3H₂ R4:
the syngas produced in the reforming section on the tube side leaves through the outlet from which it is subsequently conveyed to a further unit or section of the plant downstream of plant of class (I).

20. The process of claim 17, being carried out in the plant of type (I) wherein the reforming section is arranged under the gasification section and said plant of type (I) comprises:
an inlet for the pre-treated plastic polymer and at least one inlet for the gaseous reactants, said inlets being arranged above the gasification section of the plant of class (I);
a cyclonic section, which allows the removal of solid residues from the gaseous mixture before it is conveyed into the tube bundle on the tube side;
an outlet, in which the reacted gases are conveyed into the tube bundle.

21. The process of claim 20, wherein said pre-treated mixture of plastic polymers introduced into said plant of class (I) through the inlet, falls by gravity in equi-current with a mixture of steam and oxygen entering said plant of class (I) through the at least one inlet also arranged above the gasification section, reaching the gasification section,
in said gasification section said mixture of pre-treated polymers:
gasifies according to the endothermic reaction R1:
[—CH₂—]+H₂O═CO+2H₂ R1:
thanks to the energy developed by its partial combustion with oxygen according to the exothermic reaction R2:
[—CH₂-]+1.5O₂═CO₂+H₂O R2:
is partially transformed into methane and/or higher hydrocarbons according to the reaction R3:
[—CH₂—]ₙ+H₂═CₙH₍₂ₙ₊₂₎; R3:
wherein n is an integer comprised between 1 and 3 in the presence of hydrogen formed during the gasification according to the reaction R1 giving rise to a mixture of gases and solid residues, this reaction R3 being optionally combined with oligomer formation reactions,
and wherein:
the solid residues are separated from the gaseous mixture by the cyclonic section and the mixture of hot gases coming from the gasification is conveyed on the tube side of the tube bundle of the reforming section, where the steam reforming reaction R4 takes place:
CH₄+H₂O═CO+3H₂ R4:
the syngas produced in the reforming section on the tube side according to the reaction R4 leaves from the outlet from which it is subsequently conveyed to a further unit or section of the plant downstream of the plant of class (I).

22. The process of claim 17, being carried out in the plant of class (I) wherein the reforming section is arranged under the gasification section and said plant of class (I) comprises:
an inlet for the pre-treated plastic polymer arranged above the gasification section;
at least one inlet for the reagent gases at the bottom of the reforming section,
a recycling system at the top of the reactive unit for the gases at the top of said plant of class (I), said gases being introduced into the tube bundle on the tube side,
an exhaust tube for the gases on the shell side;
an ash removal system placed between the gasification section and the reforming section,
an outlet for the reacted gases in the tube bundle on the tube side from the plant of class (I).

23. The process of claim 22, wherein:
a mixture of oxygen and methane enters the reforming section through the at least one inlet, which supplies the thermal power to the plant of class (I) through the reaction R6:
CH₄+2O₂═CO₂+2H₂O; R6:
the gases produced by the reaction R6 rise towards the gasification section by volatilizing in countercurrent the mixture of pre-treated plastic polymers supplied to the gasification section according to the reaction R1:
[—CH₂—]+H₂O═CO+2H₂, R1:
the gas mixture exiting at the top of the plant of class (I) and coming from the gasification section is mostly sent through the recycling system in the reforming section in the tube bundle on the tube side, where reactions R4 and R5 take place to produce syngas:
CH₄+H₂O═CO+3H₂ R4:
CH₄+CO₂=2CO+2H₂ R5:
the gas produced by the reactions R4 and R5 is subsequently conveyed and sent through the outlet to a further unit or section of the plant downstream of the plant of class (I).

24. The process of claim 17, carried out in the plant of class (II) wherein the gasification reactive unit and the reforming reactive unit comprise:
a section of the gasification reactive unit arranged at the center of the gasification unit, where the gasification reaction takes place;
an inlet of the gasification reactive unit of the pre-treated polymeric material arranged above said central section of the gasification unit;
an oxygen inlet of the gasification reactive unit arranged under said central section;
an inlet of the gasification reactive unit for a pre-heated steam in a convective zone of the reforming reactive unit and conveyed to said inlet through a line;
an exhaust outlet for solid residues from the bottom of the gasification reactive unit;
an outlet of the reacted gases in the gasification reactive unit, which are then conveyed through a line and enter, through said line, in the reforming reactive unit in the tube bundle, on the tube side, said tube bundle being arranged in a radiating zone of said reforming reactive unit,
an outlet of the reforming reactive unit for the reacted gases in the tube bundle.

25. The process of claim 24, wherein said mixture of pre-treated plastic polymers:
enters the gasification reactive unit through the inlet and falls by gravity towards the bottom of the gasification reactive unit contacting in countercurrent a mixture of steam and oxygen entering said gasification unit below the central gasification section and above the exhaust outlet for solid residues, through the inlets of the oxygen and of the steam pre-heated in the convective zone of the reforming reactive unit and conveyed to said inlet through the corresponding line;
gasifies according to the endothermic reaction R1,
[—CH₂—]+H₂O═CO+2H₂ R1:
thanks to the energy developed by its partial combustion with oxygen according to the exothermic reaction R2:
[—CH₂-]+1.5O₂═CO₂+H₂O, R2:
is partially transformed into methane and/or higher hydrocarbons according to the reaction R3:
[—CH₂—]ₙ+H₂═CₙH₍₂ₙ₊₂₎; R3:
wherein n is an integer comprised between 1 and 3 in the presence of hydrogen formed during the gasification according to the reaction R1 giving rise to a mixture of gases and solid residues, this reaction R3 being optionally associated with oligomer and olefins formation reactions,
and wherein:
solid residues fall by gravity at the bottom of the gasification unit, where they are removed through the exhaust outlet;
the gas mixture coming from the gasification rises towards the top of the gasification unit from which it exits through the outlet and is sent through the line to the reforming reactive unit entering on the tube side the tube bundle arranged in the radiating zone of the reforming unit where the reforming reaction R4 takes place:
CH₄+H₂O═CO+3H₂, R4:
the gases in the tube bundle leave the reforming reactive unit through the outlet and are sent to a further unit or section of the plant downstream of the plant of class (II).

26. The process of claim 17, being carried in the plant of class (II) wherein the gasification and the reforming unit comprise
a gasification section of the gasification reactive unit arranged at the center of the gasification unit, where the gasification reaction takes place;
an inlet of the pre-treated polymeric material of the gasification reactive unit arranged above the section of the gasification unit;
an inlet of the gasification reactive unit of the burnt gases formed in the reforming unit on the shell side and which are sent to said inlet thanks to the line except for an exhaust line;
an inlet of the gasification reactive unit for the pre-heated steam in the convective area of said reforming unit;
an outlet for solid residues from the bottom of the gasification reactive unit;
an outlet of the gases reacted in the gasification unit, which are then conveyed through the line and enter said line the reforming reactive unit on the tube side in the tube bundle provided with an outlet of the reforming reactive unit for the gases reacted in the tube bundle.

27. The process of claim 26, wherein said mixture of pre-treated plastic polymers:
enters the gasification unit through the inlet and falls by gravity towards the bottom of the gasification reactive unit, contacting in countercurrent a mixture of pre-heated steam of the convective zone of the reforming reactive unit and conveyed to said inlet through the corresponding line and further steam and CO₂ deriving from the combustion of methane with oxygen according to the reaction R6:
CH₄+2O₂═CO₂+2H₂O; R6:
that takes place on the shell side in the reforming unit, a mixture that is recovered at the top of the reforming unit and is conveyed through a line and enters said gasification unit through the inlet placed under the central gasification section;
gasifies according to reaction R1:
[—CH₂—]+H₂O═CO+2H₂; R1:
the solid residues are removed through the outlet;
the reacted gases go up the gasification unit up to the top of the reactive unit from which they exit through the outlet and are sent through the relative line to the reforming reactive unit entering on the tube side the tube bundle arranged in the convective area of the reforming reactive unit, where the reactions R4 and R5 take place:
CH₄+H₂O═CO+3H₂ R4:
CH₄+CO₂=2CO+2H₂ R5:
the gases formed on the tube side of the tube bundle leave the reforming unit through the outlet and are sent to a further unit or section of the plant downstream of the reactive unit.

28. The process of claim 17, carried out in a plant selected from class (I) and (II) integrated with air separation units ASU in nitrogen and oxygen.

29. The process of claim 17, carried out in in a plant selected from class (I) and (II) and is combined with processes for the production of high added-value chemical products using syngas as reagent.

30. The process of claim 17, carried out in a plant of class (I) and (II);
wherein the gasification section or unit is of the fluid-bed type, trailed-bed type, or fixed-bed type.
